(19) United States
(12) Patent Application Publication
(10) Pub. No.: US 2025/0030212 A1
(43) Pub. Date: Jan. 23, 2025

(54) CRIMPING TOOL AND METHOD FOR CRIMPING A CRIMP SLEEVE

(71) Applicant: TE Connectivity Solutions GmbH, Schaffhausen (CH)

(72) Inventors: Uwe BLUEMMEL, Bensheim (DE); Erik GLOMBITZA, Bensheim (DE); Michael HASPEL, Bensheim (DE)

(21) Appl. No.: 18/769,491

(22) Filed: Jul. 11, 2024

(30) Foreign Application Priority Data
Jul. 18, 2023 (DE) 102023118936.0

(51) Int. Cl. H01R 43/042

(52) U.S. Cl. CPC H01R 43/042

(57) ABSTRACT

A crimping tool, in particular for a crimp applicator or a crimping machine, for crimping a crimp sleeve, in particular a crimp sleeve of an electrical crimping terminal, includes a plurality of sub-tools movable against each other, wherein an individual sub-tool has a mechanically effective sub-crimp surface global to it for partial crimping of the crimp sleeve, and at least one sub-tool, in particular exactly or at least two sub-tools, has a local measuring location insertion device within the relevant global sub-crimp surface, by means of which a measuring location can be incorporated into the crimp sleeve.

### CROSS REFERENCE TO RELATED APPLICATIONS

This application claims the benefit of DE Application No. 102023118936.0, filed 18 Jul. 2023, the subject matter of which is herein incorporated by reference in its entirety.

### BACKGROUND OF THE INVENTION

The subject matter herein relates to a crimping tool, in particular for a crimp applicator or a crimping machine, and to an assembled electrical cable. The subject matter herein also relates to a method for crimping a crimp sleeve and to a method for measuring a crimp dimension for quality assurance. In addition, the subject matter herein relates to a crimp applicator or a crimping machine.

In the electrical field (electronics, electrical engineering, electrics, electrical power engineering, etc.), a large number of electrical connection means, connection devices, socket, tab, prong, pin and/or hybrid connectors, etc. are known, which are used to transmit electrical currents, voltages, signals and/or data with a wide range of currents, voltages, frequencies and/or data rates. In the low, medium or high voltage and/or current range, and in particular in the automotive sector (low or high voltage range), such connectors must ensure a faultless transmission of electrical power, signals and/or data in warm, possibly hot, contaminated, humid, wet and/or chemically aggressive environments, in the short term and/or permanently. Owing to a wide range of applications, a large number of specially designed connectors are known.

The electrical terminals of such connectors are often configured as so-called crimp terminals, wherein the relevant crimp terminal is crimped to an electrical cable, such as a stranded electrical cable or an electrical wire etc. of the cable. Crimping is a joining process in which, for example, a crimp terminal and a cable are firmly connected to each other by plastic deformation of a crimp sleeve (crimp portion) of the crimp terminal, which can be achieved, for example, by squeezing, flanging, kinking and/or folding. Such a connection is difficult to release and ensures a high level of electrical safety and mechanical stability.

In industry, crimp connections are usually produced using crimping machines (automatic crimping machines, fully automatic crimping machines, automatic cable assembly machines, etc.), which can be used to process crimp terminals, e.g. in the form of strip goods, in order to ensure high productivity and high quality. In addition to other devices, a crimping machine naturally includes a crimping tool, e.g. a crimp applicator of the crimping machine, for producing the crimp connections between the cables and the crimp sleeves of the crimp terminals.

In order to be able to ensure consistently high quality using a crimping tool, it is necessary to measure the crimp diameter of a crimp sleeve arranged using this crimping tool. This can be carried out, for example, for all relevant crimp sleeves produced (in particular conductor crimp sleeves, insulation crimp sleeves to a certain extent); only for certain selected crimp sleeves (e.g. every 10th, 50th, 100th) or for randomly selected crimp sleeves.—Such a crimping tool has, for example, at least one crimping punch and at least one crimping anvil as sub-tools, preferably an even number of, in particular, identical pressing segments, etc. for segmented radial crimping (SRC).

There is a need to ensure and preferably improve the quality of installed crimp connections, such as installed conductor crimp connections. On the one hand, there is a need to measure the crimp diameters of the crimp connections quickly and easily and, on the other hand, there is a need to set them in relation to one another, at least within a batch, in such a way that a crimp diameter of an installed first crimp sleeve can be compared with a crimp diameter of any second crimp sleeve of this batch as far as possible.

### BRIEF DESCRIPTION OF THE INVENTION

In one embodiment, a crimping tool is provided, such as for a crimp applicator or a crimping machine, for crimping a crimp sleeve, such as a crimp sleeve of an electrical crimp terminal; by an assembled electrical cable, in particular for the automotive sector; by means of a method for crimping a crimp sleeve of an electrical crimp terminal onto an electrical conductor of an electrical cable; by a method for measuring a crimp dimension, in particular a crimp diameter, for quality assurance; and by means of a crimp applicator or a crimping machine for establishing at least one crimp connection between an electrical crimp terminal and an electrical conductor; according to the independent claims.

The features of the present specification are applicable across objects, wherein in particular a positive/negative on/in the crimping tool (sub-tool) is interchangeable with a negative/positive in/on the crimp sleeve. Advantageous developments, additional features and/or advantages of the invention can be found in the dependent claims and the following description.

The crimping tool according to the subject matter herein includes a plurality of sub-tools which can be moved against each other, wherein an individual sub-tool has a mechanically effective sub-crimp surface global to it for partial crimping of the crimp sleeve, and at least one sub-tool, in particular exactly or at least two sub-tools, has a local measuring location insertion device within the relevant global sub-crimp surface, by means of which a measuring location can be incorporated into the crimp sleeve.

The crimping tool can be configured as an automatic or manual crimping tool. In the first case, the crimping machine comprising the crimping tool can be configured as an automatic crimping machine, a fully automatic crimping machine, an automatic cable assembly machine, etc.-The crimp sleeve can generally be a portion of a means or device to be crimped, in particular that of an electrical crimping terminal, i.e. a terminal which can be crimped to a cable. The crimp sleeve can of course also be configured as an insulation crimp sleeve. In its non-crimped state, the crimp sleeve can be configured as a crimp sleeve that is closed or open at its circumference. An equivalent term to the term ‘crimp sleeve’ is, for example, ‘crimp portion’.

The crimping tool can have at least two sub-tools for a single crimp connection, in particular a crimping anvil and at least one crimping punch. In particular, the crimping tool can be configured at least in portions as a die crimping tool.—Furthermore, the crimping tool for a single crimp connection can have a plurality of, in particular even-numbered, sub-tools, which are arranged in circumferential direction of the crimping tool. In this case, the sub-tools can be fully arranged in circumferential direction, apart from the gaps between the sub-tools that are necessarily provided between them.

The crimping tool can be configured as a segmented radial crimping tool with a plurality of sub-tools, in particular even-numbered, sub-tools. In this case, all sub-tools or all sub-tools minus a single sub-tool are arranged to move back and forth in their respective radial direction (star arrangement) of the crimping tool in the crimping tool. The crimping tool can, for example, be formed as an SRC crimping tool (SRC: Segmented Radial Crimp).

The relevant sub-crimp surface can be formed in its global extent as a surface portion of a preferably singly curved or straight plane. Furthermore, the sub-crimp surface in question can be formed as a lateral portion of a rotating body, in particular as a preferably straight portion of a cylinder lateral surface. In addition, the sub-crimp surface in question can be formed as a substantially smooth sub-crimp surface.

By means of the measuring location insertion device, a measuring location can be provided on the outside of the crimp sleeve in circumferential direction and/or in axial direction of the crimp sleeve. The measuring location insertion device can be arranged as a negative or a positive in/on the global sub-crimp surface. Furthermore, at least two sub-tools located directly opposite each other in radial direction of the crimping tool can each have a measuring location insertion device. Preferably, the at least two measuring location insertion devices are located at a substantially identical position in axial direction of the crimping tool.

The measuring location insertion device can be arranged on/in the relevant sub-tool in such a way that a measuring location that can be incorporated into the crimp sleeve as a result is formed as a substantially planar (portion of a straight plane) measuring surface or a substantially convex measuring location on the outside of the crimp sleeve. Of course, two planar measuring surfaces or two convex measuring locations can preferably be introduced in radial direction in circumferential regions of the crimp sleeve that are directly opposite each other in radial direction, wherein more than two measuring locations, e.g. four measuring locations, can also be introduced in each case. For this purpose, the crimping tool has a corresponding number of measuring location insertion devices in/on sub-tools directly opposite each other in radial direction.

Furthermore, the measuring location insertion device can be arranged on/in the relevant sub-tool in such a way that the measuring location provided in the crimp sleeve can be incorporated between two crimping ribs that can emerge directly adjacently to each other in circumferential direction of the crimp sleeve. Additionally or alternatively, the measuring location that can be provided in the crimp sleeve can be incorporated into the crimp sleeve at a predetermined position in axial direction and/or at a predetermined position in circumferential direction.

The measuring location insertion device can be arranged as a groove extending in circumferential direction with a preferably straight or tangential groove base in the relevant sub-tool. The groove can run out of the relevant sub-tool on one or both sides in circumferential direction and/or can be limited by the sub-tool. In this case, the measuring location insertion device is naturally arranged as a negative in the relevant sub-tool. Furthermore, the measuring location insertion device can be arranged as a convex protrusion in the relevant sub-tool, preferably centered in circumferential direction. In this case, the measuring location insertion device is naturally arranged as a positive in the relevant sub-tool. Furthermore, the measuring location insertion device can be arranged substantially in an axial center on/in the relevant sub-tool.

The measuring location is integrally formable into the crimp sleeve by means of the measuring location insertion device. Furthermore, the measuring location can be formed out of a material of the crimp sleeve by means of the measuring location insertion device. The crimping tool can be formed in such a way that a method for crimping according to the subject matter herein can be or is carried out by means of the crimping tool.

The assembled cable according to the subject matter herein includes an electrical line and an electrical crimp terminal, wherein the crimp terminal has a crimp sleeve, by means of which the crimp terminal is crimped onto the line, in particular an electrical conductor of the line, and the crimp sleeve has at least one local measuring location, in particular exactly or at least two local measuring locations, for determining a crimp dimension, in particular a crimp diameter, of the crimp sleeve.

The crimp sleeve can have at least two measuring locations diametrically opposite each other in radial direction of the crimp sleeve. The at least two measuring locations can each be located substantially in an axial center of the crimp sleeve. And a relevant measuring location can be incorporated into the crimp sleeve as a positive or a negative. A measuring location can be located between two axial portions of a pressing portion of the crimp sleeve.

A single measuring location can be arranged as a substantially planar or convex measuring surface on the outside of the crimp sleeve. Furthermore, a single measuring location can be arranged between two directly adjacent crimping ribs in circumferential direction of the crimp sleeve. Furthermore, a single measuring location can be arranged at a predetermined position in axial direction of the crimp sleeve and/or at a predetermined position in circumferential direction of the crimp sleeve.

A single measuring location can be incorporated into the crimp sleeve as a web extending in circumferential direction of the crimp sleeve with a preferably straight or tangential extent. In this case, the measuring location is naturally incorporated into the crimp sleeve as a positive. A measuring surface of the web can be limited in circumferential direction by two directly adjacent crimping ribs or can substantially bridge them completely. In the first case, the crimping ribs are still clearly recognizable in the region of the web, whereas in the second case, the crimping ribs are no longer recognizable as ribs in the region of the web and the web substantially completely fills a circumferential space between the crimping ribs.-A single measuring location can be provided as a substantially convex measuring location on the outside of the crimp sleeve.-Furthermore, the crimp sleeve can be crimped onto the conductor using a crimping method according to the subject matter herein.

In the crimping method according to the subject matter herein, a crimp sleeve extending in axial direction is crimped onto a conductor by means of a crimping tool, in particular a crimp applicator or a crimping machine, wherein, during crimping of the crimp sleeve onto the conductor, a pressing portion is incorporated into the crimp sleeve by at least one sub-tool, in particular exactly or at least two sub-tools, of the crimping tool, wherein a local measuring location is formed into the crimp sleeve in the pressing portion.

The measuring location can be formed into the crimp sleeve by a positive/negative of the sub-tool and/or by plastic forming of a material of the crimp sleeve. A positive is in particular a material protrusion on and a negative is in particular a material recess in a global sub-crimp surface of the sub-tool. The positive/negative within the global sub-crimp surface of the sub-tool can be formed as a local measuring location insertion device, by means of which the measuring location is formed into the crimp sleeve. The measuring location insertion device can be formed as described above.

With respect to the radial direction of the crimp sleeve, two measuring locations can be formed into the crimp sleeve in diametrically opposite circumferential regions of the crimp sleeve, wherein a measuring location in question is preferably formed as a planar or convex measuring surface. A planar measuring surface can be introduced here as a web (cf. above) in a pressing portion of the crimp sleeve, wherein such a web preferably extends tangentially straight and preferably in circumferential direction of the crimp sleeve. A convex measuring surface (cf. above) can be incorporated into the crimp sleeve as a substantially convex measuring location. Of course, both the web and the measuring location are accessible from the outside of the crimp sleeve.

When arranging the crimp sleeve, axial crimping ribs can be arranged in the crimp sleeve between every two axial pressing portions of the crimp sleeve. Furthermore, when arranging the crimp sleeve, a single measuring location can be arranged between two directly neighboring crimping ribs in circumferential direction of the crimp sleeve. Preferably, this is the only measuring location between the directly adjacent crimping ribs. Furthermore, the measuring location can be arranged in the pressing portion in such a way that the pressing portion is divided into two axial portions of approximately equal length. This means, for example, that the web or the convex measuring location, i.e. the measuring location, is arranged in the center of a pressing portion.

When crimping the crimp sleeve onto the conductor, the pressing portion between two crimping ribs can be of a smooth design. This naturally also applies to the measuring location. The method can be configured as a method for assembling an electrical cable, wherein the assembled cable can be arranged as a cable assembled according to the subject matter herein. Here, of course, a crimp sleeve of an electrical crimp terminal is then crimped onto an electrical conductor of the cable in accordance with the assembly method according to the subject matter herein. The method for crimping the crimp sleeve can be followed in time by a method according to the subject matter herein for measuring a crimp dimension. In this case, the measuring method can substantially follow the crimping method directly or also with a, possibly large, time delay and/or change of location.

In the measuring method according to the subject matter herein, a measuring finger of a measuring device is placed on the outside of a pressing portion of the crimp sleeve on a crimp sleeve crimped onto an electrical conductor and the crimp dimension is measured, the measuring finger being placed on a local measuring location in the pressing portion, and the measuring location being formed as a planar or convex measuring surface on the outside of the crimp sleeve. It is preferable for two measuring fingers to be placed on such local measuring locations, with the measuring locations being formed on two sides opposite each other in radial direction on the outside of the crimp sleeve. Furthermore, a measuring location, the crimp sleeve or a crimp sleeve of an assembled cable can be configured as described above.

The invention is explained in greater detail below on the basis of exemplary embodiments with reference to the appended schematic drawings which are not to scale. Sections, elements, component parts, units, components and/or patterns which have an identical, unique or analogous configuration and/or function are identified by the same reference symbols in the description of the figures (see below), the list of reference symbols, the patent claims and in the figures (Figs) of the drawings. A possible alternative which is not explained in the description of the invention (see above), is not illustrated in the drawings and/or is not definitive, a static and/or kinematic reversal, a combination etc. with respect to the exemplary embodiments of the invention or a component, a pattern, a unit, a component part, an element or a section thereof, can further be gleaned from the list of reference symbols and/or the description of the figures.

In the case of the invention, a feature (portion, element, component part, unit, component, function, variable etc.) can be of positive configuration, that is to say present, or of negative configuration, that is to say absent. In this specification (description (description of the invention (see above), description of the figures (see below)), list of reference symbols, patent claims, drawings), a negative feature is not explained explicitly as a feature if value is not placed on it being absent according to the invention. That is to say, the invention which is actually made and is not constructed by way of the prior art consists in omitting the said feature.

A feature of this specification can be used not only in a specified manner and/or way, but rather also in another manner and/or way (isolation, combination, replacement, addition, on its own, omission, etc.). In particular, it is possible, in the description, the list of reference symbols, the patent claims and/or the drawings, to replace, add or omit a feature in the patent claims and/or the description on the basis of a reference symbol and a feature which is assigned to it, or vice versa. Furthermore, a feature in a patent claim can be interpreted and/or specified in greater detail as a result.

The features of the description can also be interpreted as optional features (in view of the (initially mostly unknown) prior art); that is to say, each feature can be considered to be an optional, arbitrary or preferred feature, that is to say a feature which is not mandatory. Therefore, a separation of a feature, possibly including its periphery, from an exemplary embodiment is possible, it then being possible for the said feature to be transferred to a generalized inventive concept. The absence of a feature (negative feature) in an exemplary embodiment shows that the feature is optional as appropriate in relation to the invention (person skilled in the art). In addition, in the case of a type term for a feature, a generic term for the feature can also be implicitly understood (possibly further hierarchical breakdown into subgenus, etc.), as a result of which a generalization of the feature is possible, for example with consideration of equivalent effect and/or equivalence.

### BRIEF DESCRIPTION OF THE DRAWINGS

In the purely exemplary and schematic figures of the drawings:

FIGS. 1 and 2 show the prior art in a side perspective view (FIG. 1) and an end-face sectional view (FIG. 2), which show a crimp sleeve of a crimp terminal crimped onto a conductor,

FIGS. 3 and 4 show an exemplary embodiment in an axial perspective view (FIG. 3) and a lateral perspective view (FIG. 4), which show sub-tools of a crimping tool in isolation (FIG. 3) and when crimping a crimp sleeve (FIG. 4),

FIG. 5 shows an exemplary embodiment in a lateral perspective view, which shows a crimp sleeve of a crimp terminal for a cable produced by a crimping method, and

FIGS. 6-8 are front-side views in each case of an exemplary embodiment, wherein the respective figure shows a crimp sleeve of an assembled cable, arranged on an electrical conductor.

### DETAILED DESCRIPTION OF THE INVENTION

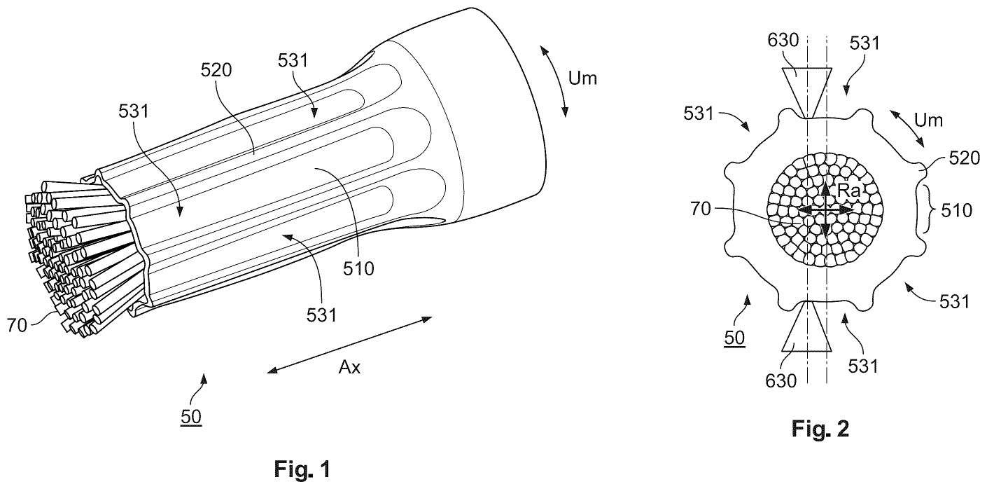

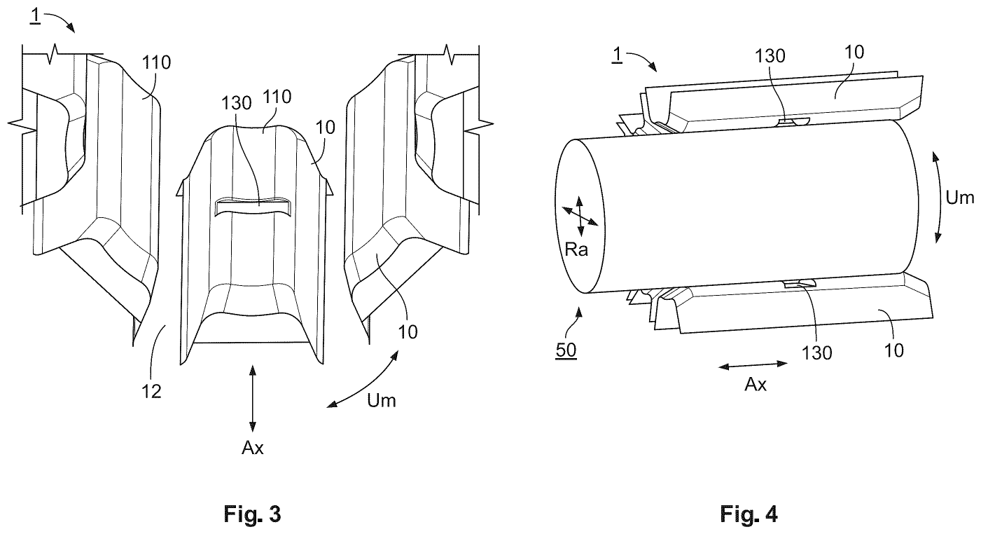

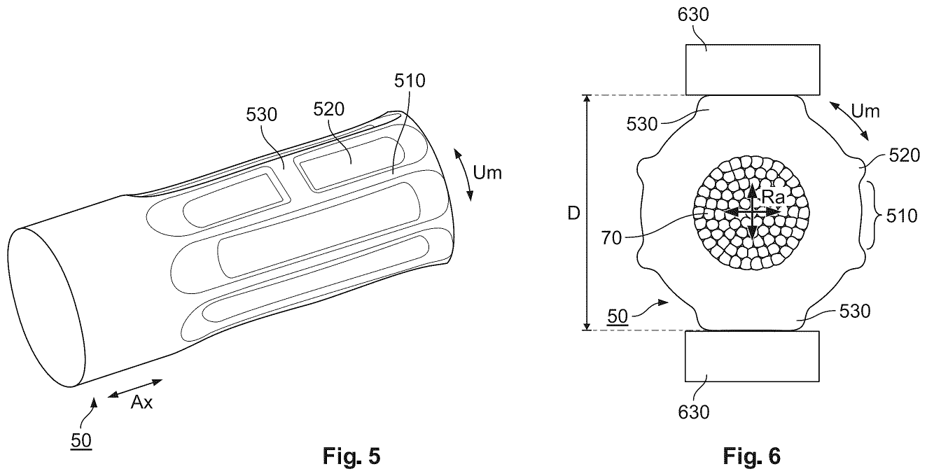

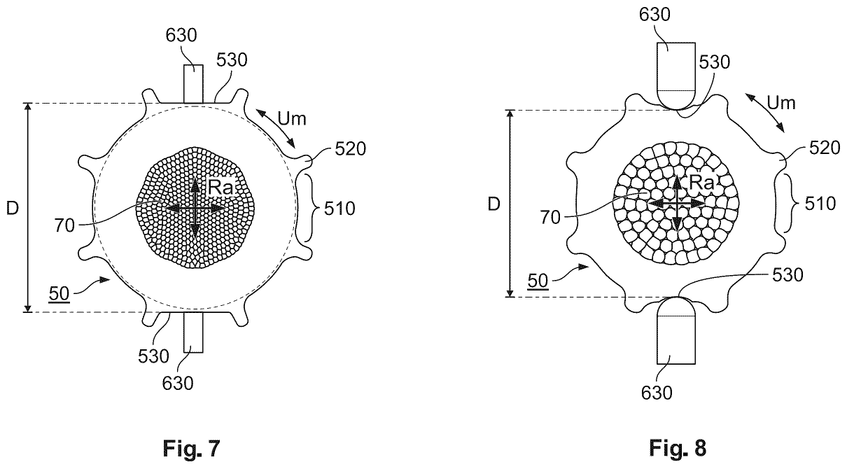

The subject matter herein is explained in greater detail below on the basis of the prior art (FIGS. 1 and 2) with reference to exemplary embodiments of a crimping tool 1 (FIGS. 3 and 4), an assembled cable (FIGS. 5 to 8), a method for crimping a crimp sleeve 50, in particular a (conductor) crimp sleeve 50 of an electrical crimp terminal (FIGS. 4 and 5), and a method for measuring a crimp dimension D (FIGS. 6 to 8). Of course, the subject matter herein is also applicable to another crimping tool, another assembled cable or another method for crimping and/or measuring.

Although the subject matter herein is described and illustrated further in greater detail by way of preferred exemplary embodiments, the subject matter herein is not restricted by the disclosed exemplary embodiments, but rather is of a more fundamental nature. Other variations can be derived therefrom and/or from the above (description of the invention), without departing from the scope of protection of the invention. The subject matter herein can generally be applied in the electrical sector, i.e. for example in the automotive sector or also in the non-automotive sector, in the case of an electrical entity.

The drawings show only those physical sections of a subject matter of the invention which are necessary for understanding the invention. Designations such as connector and mating connector, terminal and mating terminal etc. are to be interpreted synonymously, that is to say may be mutually interchangeable. The explanation of the invention (cf. also above) on the basis of the drawing refers in the following, inter alia, to a (bidirectional) axial direction Ax, a (multidirectional) radial direction Ra and a (bidirectional) circumferential direction Um of the crimping tool 1 or a sub-tool 10 of the crimping tool 1, the crimp sleeve 50, the assembled cable, etc.

FIGS. 1 and 2 show a crimp sleeve 50 crimped onto an electrical conductor 70 in accordance with the prior art, wherein the crimp sleeve 50 has been arranged on the conductor 70 using eight identical sub-tools of an SRC crimping tool. For setting up axial Ax pressing portions 510 of the crimp sleeve 50, each of the sub-tools has a sub-crimp surface global to it, which is formed as a straight portion of a cylinder lateral surface (cf. the two left-hand and the two right-hand sub-tools 10 in FIG. 3). Such a pressing portion 510 forms a comparatively large circumferential portion of the crimp sleeve 50 on the conductor 70 in comparison with a crimping rib 520 (cf. below).

Sub-tool gaps 12 are necessarily arranged between each two directly adjacent sub-tools 10 in circumferential direction Um of the SRC crimping tool (cf. again FIG. 3). Sub-tool gaps 12 cause axial Ax crimping ribs 520 in the crimp sleeve 50 arranged on the conductor 70 during crimping. Such a crimping rib 520 forms a comparatively small circumferential portion of the crimp sleeve 50 on the conductor 70 in comparison with a pressing portion 510.

With eight sub-tools, four times two diametrically opposite pressing portions 510 are created with respect to the axial direction Ax, in which a crimp dimension D of the crimp sleeve 50 can be measured. Furthermore, the respective crimp dimension D can be measured along a substantially entire axial Ax extent of the pressing portions 510. In addition, the curved global sub-crimp surfaces of the sub-tools result in convex measuring locations 531 (FIG. 2). These convex formations of the pressing portions 510 are necessary to ensure a good crimp.

With regard to a measurement of the crimp dimension D, a number of uncertainties now arise. Which of the four directions (four opposite pairs of pressing portions 510/510) should be measured? At which axial Ax position of a pressing portion pair 510/510 should a measurement be taken? Furthermore, a measurement of the crimp dimension D requires a special measuring device (tip geometry) in order to be able to measure between the crimping ribs 520 of two opposing pressing portions 510, which is illustrated in FIG. 2.

The comparatively pointed tip geometry of the two measuring fingers 630 in FIG. 2 is obviously unsuitable for providing reproducible measurement results due to the convex measuring locations 531. If the tips of the measuring fingers 630 are too small, eccentric measuring positions are possible, which results in incorrect crimp dimensions D, in particular crimp diameter D, at the convex measuring locations 531. However, such tip geometries or standard tip geometries, for example, can be used to measure the crimp dimension D.

Particularly with SRC crimping tools for circumferentially closed crimp sleeves 50, a crimp diameter D is the primary control dimension that must be set correctly. The shape of the sub-tools 10 which is common in the prior art results in eight pressing portions 510, which together with eight crimping ribs 520 form the crimp sleeve 50 in circumferential direction Um. In the case of a crimp sleeve 50 arranged on a conductor 70, the distance between opposing pressing portions 510, i.e. a crimp diameter D, should be the same for all four directions over the entire length of the pressing portions 510.

Due to tolerances of the crimping tool itself and due to tolerances occurring during the execution of a crimping process, the crimp diameter D can vary in axial direction Ax and/or in circumferential direction Um of the crimp sleeve 50 depending on a position of a measuring location, i.e. where the measuring fingers 630 (cf. FIGS. 6 to 8) of a measuring device are applied to/on the crimp sleeve 50. The measurement must also exclude the crimping ribs 520 between the P pressing portions 510, which requires a measuring tip geometry geometrically linked to the size of the crimp sleeve 50 in order to reduce inconsistencies in the measurements.

So where is the right place to measure? In the course of investigations, it was found that even a reliable determination of a single crimp diameter D in an axial Ax center of a crimp sleeve 50 provides a reliable result. This means that the quality of an installed crimp sleeve 50 can be easily determined with a single, simple measurement. Due to the, in particular, convex measuring locations 531 in the prior art, such a reliable determination of a crimp diameter D can only be realized with restrictions (tip geometry of the measuring fingers 630 adapted to the crimp sleeve 50, ensuring a correct position of the crimp sleeve 50 with respect to the measuring fingers 630, excluding the crimping ribs 520, etc.).

According to the invention, at least one measuring location 530 is provided in the crimp sleeve 50 according to the invention by means of a crimping tool 1 according to the invention in a crimping method according to the invention, wherein a crimp dimension D, in particular a crimp diameter D, of the crimp sleeve 50 can be measured in accordance with the invention by means of the measuring location 530 according to the invention. The crimp sleeve 50 is preferably that of a crimp terminal, e.g. a crimp terminal of an assembled cable.

Here, in radial direction Ra of the crimp sleeve 50, in particular exactly two or a plurality of diametrically opposed measuring locations 530 are arranged in pairs on/in the crimp sleeve 50. In this case, measuring locations 530 relating to one another have the same axial Ax position in/on the crimp sleeve 50. A measuring finger 630 of a measuring device can then be placed on the outside of the crimp sleeve 50 at a single measuring location 530 and the crimp dimension D can be measured.—Alternatively, another crimping tool, for example comprising a crimping anvil and at least one crimping punch, can of course be used.

The crimping tool 1 or SRC crimping tool 1 (cf. FIGS. 3 and 4) is constructed globally as described above for this purpose. However, at least one sub-tool 10 has a local measuring location insertion device 130 arranged as a negative in and/or as a positive on the global sub-crimp surface 110. Preferably, two sub-tools 10 lying opposite one another in radial direction Ra or a plurality of such sub-tools 10 lying opposite one another in pairs have such local measuring location insertion devices 130 in/on their global sub-crimp surfaces 110. Such a measuring location insertion device 130 can be configured as described above.

As a negative, the measuring location insertion device 130 is arranged in particular as a groove 130 preferably substantially in an axial Ax center in the relevant sub-tool 10 (cf. FIGS. 3 and 4). Preferably, the groove 130 extending into the global sub-crimp surface 110 of the relevant sub-tool 10 has a straight or tangential (with respect to a curvature of a sub-crimp surface 110) groove base. Of course, other negatives are also possible as measuring location insertion devices 130, such as, for example: an indentation, a bead, etc. A negative is, for example, a lack of material in the global sub-crimp surface 110 or a recess-like deviation from a regular surface of the global sub-crimp surface 110.

As a positive, the measuring location insertion device 130 is arranged in particular as a convex protrusion 130 preferably substantially in an axial Ax center in the relevant sub-tool 10 (not shown in the figures). Preferably, the convex protrusion 130 is formed on the global sub-crimp surface 110 of the relevant sub-tool 10 as a portion of an ellipsoid or a solid sphere. Of course, other positives are also possible as measuring location insertion devices 130, such as, for example: a protrusion, a beam shape, etc. A positive is, for example, an additional material at/on the global sub-crimp surface 110 or a protrusion-like deviation from a regular surface of the global sub-crimp surface 110.

The crimp sleeve 50 (cf. FIGS. 5 to 8), for example of the terminal, has at least one local measuring location 530 for determining a crimp dimension D, in particular a crimp diameter D, of the crimp sleeve 50 at/in at least one of its pressing portions 510. Preferably, the crimp sleeve 50 has two measuring locations 530 diametrically opposite one another in radial direction Ra or a plurality of such pairs of diametrically opposite measuring locations at/in its pressing portions 510. Such a measuring location 530 can be configured as described above.

The crimp sleeve 50 has, analogously to a negative as the measuring location insertion device 130 of the crimping tool 1, a preferably axially centered positive as the measuring location 530 (cf. FIGS. 5 to 7), or, analogously to a positive as the measuring location insertion device 130 of the crimping tool 1, a preferably axially centered negative as the measuring location 530 (cf. FIG. 8). In principle, such a negative or such a positive can be of any shape, as long as measuring surfaces of the measuring locations 530 can be realized, on which measuring fingers 630 can be placed.

As a single positive measuring location 530, this can be configured, for example, as a web 530 which extends in circumferential direction Um of the crimp sleeve 50. Preferably, the web 530 has a straight or tangential extent (with respect to a circumferential Um curvature of a pressing portion 510 or crimp sleeve 50). The web 530 can be arranged here between two directly adjacent crimping ribs 520. In a first case, a measuring surface of the web 530 can completely bridge two directly adjacent crimping ribs 520 (FIGS. 5 and 6), and, in a second case, a measuring surface of the web 530 can be arranged between two directly adjacent crimping ribs 520 (FIG. 7).

As a single negative measuring location 530, this can be formed, for example, as a substantially convex measuring location 530 in a pressing portion 510 of the crimp sleeve 50 (FIG. 8).—The positive or negative measuring location 530 can have a substantially planar or convex measuring surface, which is arranged on the outside of the crimp sleeve 50. In this case, a single measuring surface is arranged between two directly adjacent crimping ribs 520 or bridges them. If necessary, a concave measuring surface of a measuring location 530 can of course also be arranged.

In the crimping method, a local measuring location 530 is formed into the resulting pressing portion 510 of the crimping crimp sleeve 50 during crimping of the crimp sleeve 50. In particular, the measuring location 530 is formed into the pressing portion 510 by plastic forming of a material of the crimp sleeve 50. Preferably, at least one pair of measuring locations 530/530 is formed into the relevant pressing portions 510, wherein the measuring locations 530, 530 of the pair of measuring locations 530/530 are diametrically opposite one another with respect to the radial direction Ra of the crimp sleeve 50.

As above, a single measuring location 530 is arranged between two directly adjacent crimping ribs 520 in the crimping process. The measuring location 530 can divide the pressing portion 510 into which it has been formed into two axial (Ax) portions, which can preferably be approximately the same length.

The crimp dimension D, in particular the crimp diameter D, can be measured after the crimping process. In this case, the measuring process can take place shortly after the crimping process or also later, for example at a different location. In the measuring method, a measuring finger 630 is no longer positioned on a pressing portion 510 (cf. FIG. 1), but is placed on a local measuring location 530 in the pressing portion 510. As above, the measuring location 530 can be configured as a planar or convex measuring surface. If necessary, a convex measuring surface can also be provided.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. Crimping tool for crimping a crimp sleeve of an electrical crimping terminal, the crimp tool comprising:
a plurality of sub-tools movable against each other during crimping, wherein an individual sub-tool has a mechanically effective sub-crimp surface global to it for partial crimping of the crimp sleeve,
wherein at least one of the sub-tools has a local measuring location insertion device within the relevant global sub-crimp surface, the local measuring location insertion device configured to form a measuring location into the crimp sleeve during crimping.

2. Crimping tool according to claim 1, wherein the plurality of sub-tools includes a crimping anvil and at least one crimping punch.

3. Crimping tool according to claim 1, wherein the plurality of sub-tools includes even-numbered sub-tools arranged in circumferential direction of the crimping tool.

4. Crimping tool according to claim 1, wherein the measuring location insertion device is configured to form the measuring location on an outside of the crimp sleeve in at least one of a circumferential direction and/an axial direction of the crimp sleeve.

5. Crimping tool according to claim 1, wherein the measuring location insertion device is configured to form the measuring location as a negative or a positive measuring location in/on the global sub-crimp surface.

6. Crimping tool according to claim 1, wherein the plurality of sub-tools includes two sub-tools located directly opposite each other in a radial direction of the crimping tool each having the corresponding measuring location insertion device.

7. Crimping tool according to claim 1, wherein the measuring location insertion device includes a groove extending in circumferential direction with a straight groove base in the relevant sub-tool.

8. Crimping tool according to claim 1, wherein the measuring location insertion device includes a convex protrusion in the relevant sub-tool centered in circumferential direction.

9. Crimping tool according to claim 1, wherein the measuring location insertion device is arranged substantially in an axial center on/in the relevant sub-tool.

10. Assembled electrical cable comprising:
an electrical line and an electrical crimp terminal, the crimp terminal having a crimp sleeve crimped onto an electrical conductor of the line, the crimp sleeve including at least one local measuring location for determining a crimping dimension of the crimp sleeve.

11. Assembled electrical cable according to claim 10, wherein the at least one local measuring location determines a crimping diameter of the crimp sleeve.

12. Assembled electrical cable according to claim 10, wherein the at least one local measuring location includes at least two measuring locations diametrically opposite each other in a radial direction of the crimp sleeve.

13. Assembled electrical cable according to claim 10, wherein the at least one local measuring location includes a single measuring location arranged on an outside of the crimp sleeve between two directly adjacent crimping ribs in a circumferential direction of the crimp sleeve.

14. Assembled electrical cable according to claim 10, wherein the at least one local measuring location includes a single measuring location incorporated into the crimp sleeve as a web extending in a circumferential direction of the crimp sleeve with a straight extent, the web including a measuring surface limited in the circumferential direction by two directly adjacent crimping ribs.

15. Crimping method for connecting a crimp sleeve of an electrical crimp terminal to an electrical conductor of an electrical cable, the crimping method comprising:
crimping the crimp sleeve, extending in axial direction, onto the conductor using a crimping tool having at least two sub-tools to form a pressing portion into the crimp sleeve by the at least two sub-tools;
forming a local measuring location into the crimp sleeve in the pressing portion by the at least two sub-tools.

16. Crimping method according to claim 15, wherein said forming the local measuring location into the crimp sleeve is formed by a positive or negative of the sub-tool and by plastic forming of a material of the crimp sleeve.

17. Crimping method according to claim 15, wherein said forming the local measuring location into the crimp sleeve includes forming, with respect to a radial direction of the crimp sleeve, two measuring locations into the crimp sleeve in diametrically opposite circumferential regions of the crimp sleeve.

18. Crimping method according to claim 15, characterized in that when setting up the crimp sleeve:
axial crimping ribs are arranged in the crimp sleeve between every two axial pressing portions of the crimp sleeve,
a single measuring location is arranged between two directly adjacent crimping ribs in circumferential direction of the crimp sleeve, and
the measuring location is arranged in the pressing portion in such a way that the pressing portion is divided into two axial portions of approximately equal length.

19. Crimping method according to claim 15, further comprising measuring a crimp dimension for quality assurance by placing a measuring finger of a measuring device on the outside of a pressing portion of the crimp sleeve to measure the local measuring location in the pressing portion.

20. Crimp applicator for establishing at least one crimp connection between an electrical crimp terminal and an electrical conductor, the crimp applicator comprising:
a crimping tool including a plurality of sub-tools movable against each other during crimping, wherein an individual sub-tool has a mechanically effective sub-crimp surface global to it for partial crimping of the crimp sleeve, wherein at least one of the sub-tools has a local measuring location insertion device within the relevant global sub-crimp surface, the local measuring location insertion device configured to form a measuring location into the crimp sleeve during crimping.
